(19) United States
(12) Patent Application Publication
(10) Pub. No.: US 2016/0083994 A1
(43) Pub. Date: Mar. 24, 2016

(54) DOOR STOPPER

(71) Applicant: George Duenas, Walnut, CA (US)

(72) Inventor: George Duenas, Walnut, CA (US)

(21) Appl. No.: 14/863,320

(22) Filed: Sep. 23, 2015

Related U.S. Application Data
(60) Provisional application No. 62/054,001, filed on Sep. 23, 2014.

(51) Int. Cl. E05F 5/02

(52) U.S. Cl. CPC E05F 5/02

(57) ABSTRACT

A door stopper may include a control unit, a connecting piece and a rod. The control unit is anchored to the floor. One end of the connecting piece is connected to the control unit and the rod is mounted on the other end of the connecting piece. When the user needs the door to be retained, he/she can move the door toward the door stopper and slightly contact the top portion of the control unit to activate it, and the control unit will start to drive the connecting piece along with the rod to move about ninety degrees away from the wall to stop the door. Namely, the door stopper moves a quadrant from the lower portion of the wall surface to a lower portion of the door, and the door will be trapped between the control unit and the rod.

### CROSS-REFERENCE TO RELATED APPLICATIONS

This application claims priority under 35 U.S.C. §119 (e) to U.S. Provisional Patent Application Ser. No. 62/054,001 filed on Sep. 23, 2014, the entire contents of which are hereby incorporated by reference.

### FIELD OF THE INVENTION

This invention is related to a door stopper, and more particularly to a door stopper which can be automatically triggered to hold a door open and prevent a door from banging and damaging nearby walls.

### BACKGROUND OF THE INVENTION

Door stopper is widely used for several decades. A conventional way to hold a door open is to use a small wedge, which is placed between a lower portion of the door and the floor to frictionally impede the return of the door to the closing position. However, if the force exerted by the door closer overcomes the frictional resistance, the wedge will not hold the door open properly and then escape along the floor. Another method is to provide a hook which is engaged with a ring mounted on the door to hold the door open. Both methods are defective since the wedge must be manually placed and taken out, and the hook must be manually engaged and disengaged. In addition, neither method provides buffer efficacy to prevent a door from banging and damaging nearby walls.

U.S. Pat. No. 6,016,588 to Kamerschen discloses a door catch and stop including a one piece plastic molded elongated member having a mounting portion at one end and main portion at the other end connected by an hour glass portion acting as a spring to allow the main portion to be deflected aside by a door edge engaging a cam surface formed thereon. A wide notch formed into the top of the main portion captures the door when the door edge moves into the notch as shown in FIG. 1. However, the door stop in the '588 patent is protruding from the lower portion of the wall, which may trip people walking nearby or even hurt people. Moreover, the opening of the door stop is fixed, and does not seem to fit the door of different sizes.

U.S. Pat. No. 6,161,252 to Rodriguez discloses a door holder assembly used to maintain a door in an opened position as shown in FIG. 2. The assembly has a door stop, a locking plate mounted on the door and a floor mounted door holder. The door stop and the door holder are fixed to the floor while the locking plate is fixed to the lower portion of the door and is positioned to engage the door holder when the door is opened. The locking plate has two joined segments one of which is planar and flat while the other of which has a right angled groove. Depending on the vertical elevation of the door's bottom above the floor, the same locking plate can be mounted to the door in one of two different positions. However, the door stop and the door holder have to be fixed to the floor, which is inconvenient for the users and would cause damages to the floor. Also, like the door stop in the '588 patent, people may be tripped or injured by the door stop or door holder on the floor. Therefore, there remains a need for a new and improved door stopper to overcome the problems stated above.

### SUMMARY OF THE INVENTION

It is an object of the present invention to provide a door stopper which can be triggered automatically to hold a door open.

It is another object of the present invention to provide a door stopper which can prevent a door from banging and damaging nearby walls.

It is a further object of the present invention to provide a door stopper which is configured to move a quadrant from the lower portion of the wall surface to a lower portion of the door being stopped.

It is a further object of the present invention to provide a door stopper which is configured to measure the distance between the door and the door stopper, and when the door is within a predetermined distance from the door stopper, the door stopper is triggered to move toward the door.

In one aspect, a door stopper may include a control unit, a connecting piece and a rod. The control unit is anchored to the floor and its top portion is covered with rubber for buffering purposes. The control unit is disposed on one end of the connecting piece, while the rod is mounted on the other end thereof. It is noted that the door stopper can be activated or deactivated. When the user needs the door to be retained, he/she can move the door toward the door stopper and slightly contact the top portion of the door stopper to activate it, and the control unit will start to drive the connecting piece along with the rod to move about ninety (90) degrees away from the wall to stop the door. Namely, the door stopper moves a quadrant from the lower portion of the wall surface to a lower portion of the door, and the door will be trapped between the control unit and the rod.

To close the door, the user may hit the control unit with the door again and the control unit will drive the connecting piece with the rod back. It is noted that when the door stopper is not in use, it is substantially aligned with the wall, so people walking nearby will less likely to be tripped or even injured by the door stopper. Furthermore, since the door stopper is disposed between the door and the wall surface, the door stopper can be used as a buffer to prevent the door from banging and damaging the wall. In another embodiment, the connecting piece can also be manually moved to stop the door.

### BRIEF DESCRIPTION OF THE DRAWINGS

FIG. 1 illustrates a prior art disclosing a door catch and stop.

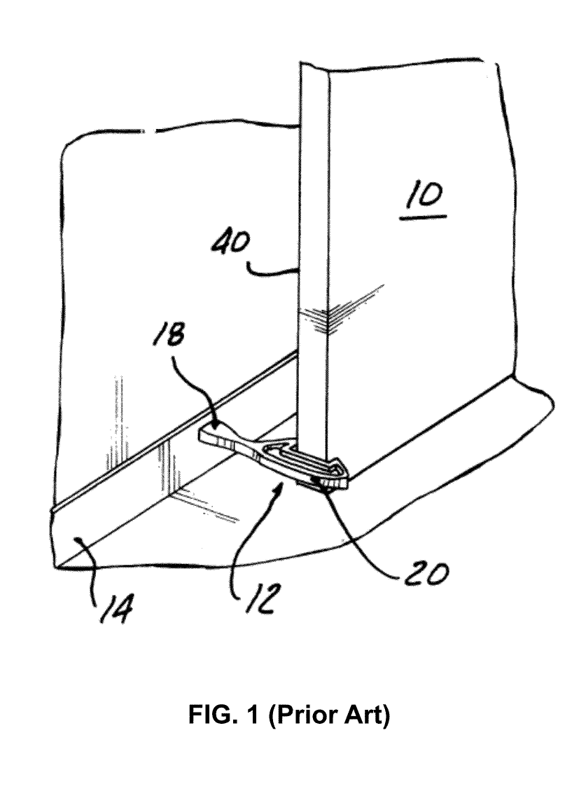

FIG. 2 illustrates a prior art disclosing a door holder assembly used to maintain a door in an opened position.

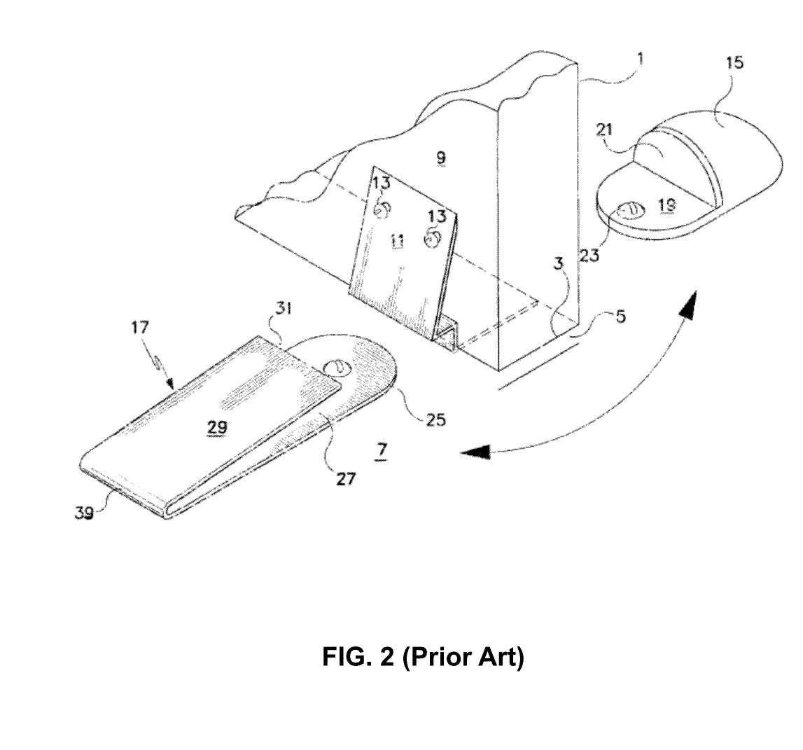

FIG. 3 illustrates a perspective view of the door stopper in the present invention.

FIG. 4 illustrates a schematic view of the door stopper in the present invention when in use.

FIG. 5 illustrates a schematic view of another aspect of the door stopper in the present invention.

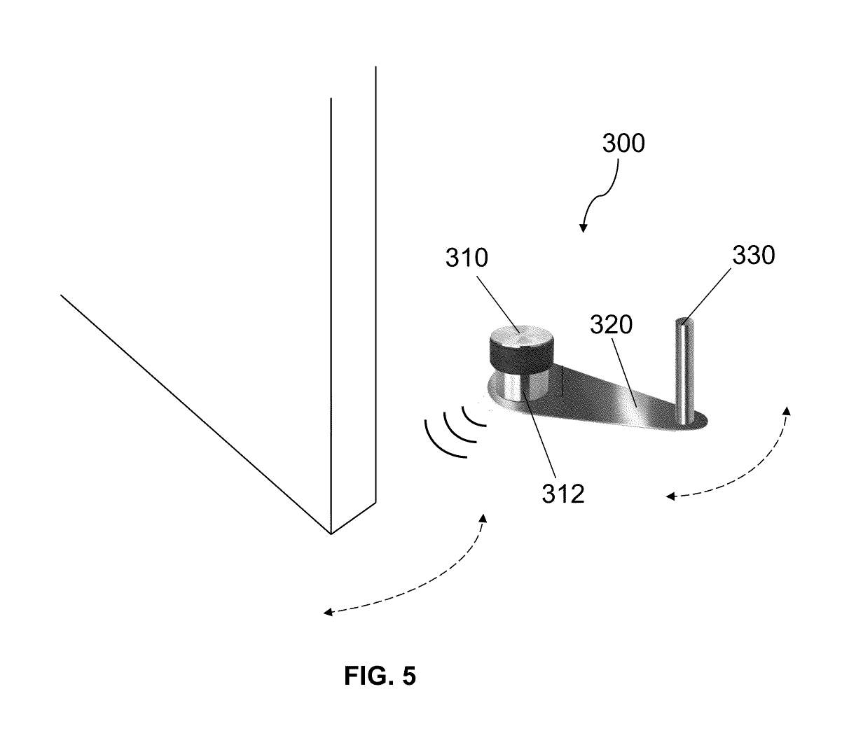

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, an embodiment along with the drawings are illustrated as following:

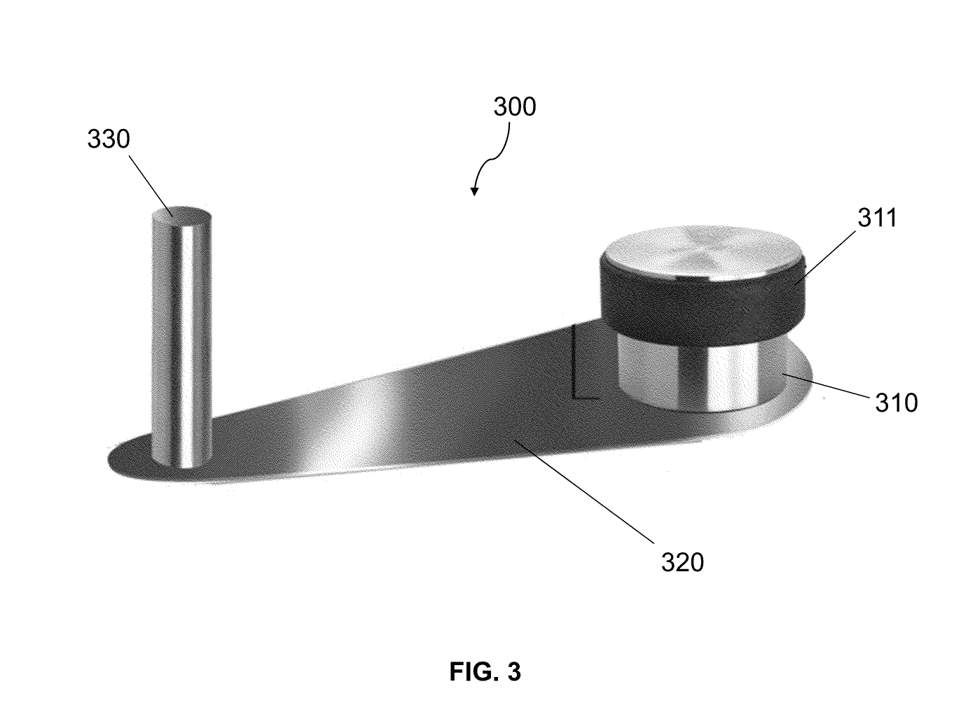

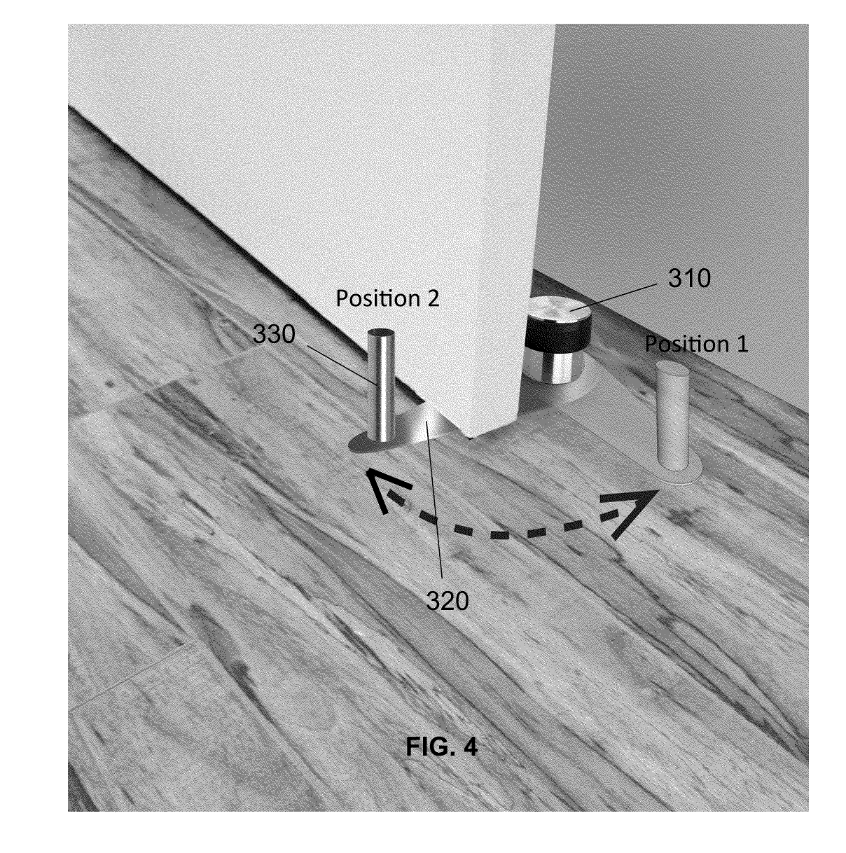

Referring to FIGS. 3 and 4, in one aspect, a door stopper 300 comprises a control unit 310, a connecting piece 320 and a rod 330. The control unit 310 is anchored to the floor and its top portion 311 is covered with rubber for buffering purposes. The control unit 310 is disposed on one end of the connecting piece 320, while the rod 330 is mounted on the other end thereof.

It is noted that the door stopper 300 can be activated or deactivated. When the user needs the door to be retained, he/she can move the door toward the door stopper 300 and slightly contact the top portion 311 of the door stopper 300 to activate it, and the control unit 310 will start to drive the connecting piece 320 along with the rod 130 to move about ninety (90) degrees away from the wall to stop the door (from Position 1 to Position 2). Namely, the door stopper 300 moves a quadrant from the lower portion of the wall surface to a lower portion of the door, and the door will be trapped between the control unit 310 and the rod 330 as shown in FIG. 4. It is noted that when the door stopper 300 moves to Position 2, the control unit 310 may apply a predetermined force to slightly push the door stopper 300 down to secure it at Position 2, so it will not be easily kicked away from Position 2 when people walking by.

To close the door, the user may hit the control unit 310 with the door again and the control unit 310 will drive the connecting piece 320 with the rod 330 to swing back to Position 1. It is noted that when the door stopper 300 is at Position 1, it is substantially aligned with the wall, so people walking nearby will less likely to be tripped or even injured by the door stopper 300. Furthermore, since the door stopper 300 is disposed between the door and the wall surface, the door stopper 300 can be used as a buffer to prevent the door from banging and damaging the wall. In another embodiment, the connecting piece 320 can also be manually moved to stop the door.

In another aspect, the control unit 310 may further include a distance sensor 312, which is configured to measure a distance between the control unit 310 and the door. When the user wants to keep the door open and moves the door toward the door stopper 300, the distance between the door and the control unit 310 decreases and when the distance therebetween is within a predetermined range, the distance sensor 312 triggers the control unit 310 to drive the connecting piece 312 to move toward the door, so the door can be retained by the door stopper 300 as soon as reaching Position 2 without physically contacting the control unit 310 as stated above. In another embodiment, a light sensor may be used to trigger the control unit.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A door stopper comprising:
a control unit anchored to the floor and configured to control movement of the door stopper;
a rod with a predetermined height to stop a door;
a connecting piece; said control unit disposed at one end of the connecting piece and the rod disposed at the other end thereof,
wherein when the control unit is contacted by the door, the control unit is triggered to drive the connecting piece with the rod to move a quadrant from a lower portion of a wall surface to a lower portion of the door to trap the door between the control unit and the rod.

2. The door stopper of claim 1, wherein the control unit is configured to apply a predetermined force to push down the connecting piece to prevent the door stopper from moving around.

3. The door stopper of claim 1, wherein the door stopper is configured to restore to an original position when it is contacted again by the door.

4. The door stopper of claim 1, wherein the door stopper is disposed between the door and the wall surface and used as a buffer to prevent the door from banging and damaging the wall surface.

5. The door stopper of claim 1, wherein the control unit further comprises a distance sensor.

6. The door stopper of claim 1, wherein the distance sensor is configured to measure a distance between the control unit and the door, and when the door moves toward the door stopper, the distance sensor triggers the control unit to drive the connecting piece to move toward the door when the distance therebetween is within a predetermined range, so the door and the door stopper reach a predetermined retaining position at nearly the same time.
